(19) United States
(12) Patent Application Publication
(10) Pub. No.: US 2014/0180799 A1
(43) Pub. Date: Jun. 26, 2014

(54) TECHNIQUES FOR OPTIMIZING THE IMPACT OF VIDEO CONTENT ON ELECTRONIC COMMERCE SALES

(71) Applicant: Invodo, Inc., Austin, TX (US)

(72) Inventors: James David Keeler, Austin, TX (US); Lane Stafford Wimberley, Austin, TX (US)

(73) Assignee: INVODO, INC., Austin, TX (US)

(21) Appl. No.: 14/140,804

(22) Filed: Dec. 26, 2013

Related U.S. Application Data
(60) Provisional application No. 61/746,092, filed on Dec. 26, 2012.

(51) Int. Cl. G06Q 30/02

(52) U.S. Cl. CPC G06Q 30/0246
USPC 705/14.45

(57) ABSTRACT

A technique for measuring a video profit for a product includes performing an A/B test for a product while monitoring for customer conversion. In this case, at least one of ‘A’ and ‘B’ correspond to video. A unique number of visitors to a product webpage that viewed a call-to-action for a video of the product is determined based on the test. A gain that accounts for customer bias is determined based on the test. A non-viewer conversion rate is determined based on the test. A video view rate is determined based on the test. A video conversion lift is determined based on the test. An abandonment factor is determined based on the test. Finally, an incremental video profit for the product is determined based on the unique number of visitors, the gain, the non-viewer conversion rate, the video view rate, the video conversion lift, and the abandonment factor.

This application claims the benefit of the filing date of U.S. Provisional Patent Application Ser. No. 61/746,092, filed Dec. 26, 2012, the disclosure of which is hereby incorporated herein by reference in its entirety for all purposes.

### BACKGROUND

1. Field

This disclosure relates generally to electronic commerce and, more specifically, to techniques for optimizing the impact of video content on electronic commerce sales.

2. Related Art

The term electronic commerce (e-commerce) is used to refer to an industry where the buying and selling of products or services is conducted over electronic systems, such as the Internet and other computer networks. E-commerce may employ various technologies, e.g., mobile commerce, electronic funds transfer, supply chain management, Internet marketing, online transaction processing, electronic data interchange, inventory management systems, and automated data collection systems. Today, e-commerce typically employs the World Wide Web at least at one point in a transaction lifecycle, although e-commerce may encompass a wider range of technologies, e.g., electronic mail (email), mobile devices, social media, and telephones. E-commerce is generally thought to include the sales aspect of e-business and normally includes the exchange of data to facilitate the financing and payment aspects of business transactions.

### SUMMARY

A technique for measuring a video profit for a product includes performing an A/B test for a product while monitoring for customer conversion. In this case, at least one of ‘A’ and ‘B’ correspond to video. A unique number of visitors to a product webpage that viewed a call-to-action for a video of the product is determined based on the test. A gain that accounts for customer bias is determined based on the test. A non-viewer conversion rate is determined based on the test. A video view rate is determined based on the test. A video conversion lift is determined based on the test. An abandonment factor is determined based on the test. Finally, an incremental video profit for the product is determined based on the unique number of visitors, the gain, the non-viewer conversion rate, the video view rate, the video conversion lift, and the abandonment factor.

### BRIEF DESCRIPTION OF THE DRAWINGS

Embodiments of the present invention are illustrated by way of example and are not limited by the accompanying figures, in which like references indicate similar elements. Elements in the figures are illustrated for simplicity and clarity and have not necessarily been drawn to scale.

FIG. 1 is a graph depicting viewing and purchasing behavior of video viewers.

FIG. 2 is a view of an exemplary video player.

FIG. 3 is a view of an exemplary A/B test using a video presenter (A) and video voiceover (B).

FIG. 4 is a diagram of an exemplary data processing system that is configured to evaluate videos according to the present disclosure.

FIGS. 5-13 depict a process for transforming a data structure represented as a decision tree of arbitrary complexity into reduced complexity decision trees.

FIG. 14 includes Table 3, which provides a comparison of parameters for various categories of retail products and shows the results of these parameters being used to populate a database for different product categories to determine statistical results for each category.

FIG. 15 is a flowchart of a process for measuring video profit according to an embodiment of the present invention.

FIG. 16 is a flowchart of a process for estimating video profit via a database of statistical values for each category of profit without requiring an A/B test, according to an embodiment of the present invention.

FIG. 17 is a view of an exemplary video player that is configured to include links to offer different products that are determined by a recommendation/optimization engine that accesses a database product category information and/or personalized information, according to an embodiment of the present invention.

### DETAILED DESCRIPTION

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims and their equivalents. As may be used herein, the term ‘coupled’ encompasses a direct electrical connection between elements or components and an indirect electrical connection between elements or components achieved using one or more intervening elements or components.

Embodiments of the present disclosure are generally directed to the field of Internet electronic-commerce (e-commerce) and business services where video or other dynamic media is presented to a user based on optimized predictions of behavior in view of estimates of customer purchase behavior. E-commerce has evolved from presenting static images and text to potential customers to presenting videos to potential customers. While e-commerce websites have presented potential customers with videos related to products and/or services, little has been done to determine the best types of videos for converting customer behavior into desired actions (e.g., purchases). Aspects of the present disclosure are directed to techniques for measuring customer behavior, building a predictive behavioral model, and then using the predicted behavioral model to enhance video performance based on measured parameters.

A number of articles have reported that video has a positive impact on sales in e-commerce. Typical reported results for the impact of video in increasing sales range from 3 to 30 percent. In this case, assuming sales of $1,000,000 per year without video, one would expect to increase sales between $30,000 to $300,000 per year with video. Increased sales results due to video have usually been reported based on single case studies. Moreover, a single comprehensive report on video impact on sales in e-commerce that aggregates a wide variety of customers in detail has not traditionally been available. As disclosed herein, a single report is generated that provides data on over thirty different customers with detailed studies and performance ranges. The standard method of video/no-video testing has traditionally only provided an overall performance measurement and has not provided insight on how to improve video performance. As is disclosed herein, different elements of video performance are dissected into a video profit equation (VPE) that accounts for certain elements that impact video yield so that the impact of video on sales may be better understood. The different elements of video performance may then be examined and optimized to improve video performance.

Video in e-commerce is growing rapidly. For example, only a few years ago it was rare to see video on e-commerce websites. Today, however, most e-commerce websites employ video. In general, the number of videos on retailer websites has grown. In fact, it is not unreasonable to assume that just about every picture and text description of a product will be augmented or replaced with a video on most e-commerce retail websites in the near future. One of the reasons for the increase in the popularity of videos in e-commerce is that videos increase conversion. For example, a study reported in comScore Video Metrix 2.0 in June of 2010 reported that retail website visitors who also view video are sixty-four percent more likely to purchase. The study also indicates that retail site visitors that view video also spend two minutes longer on a website per visit.

From the study, one may assume that the reason for the explosive growth in video in e-commerce is that videos work to improve sales. Typically, a video return-on-investment (ROI) may be measured in months. For example, an investment of $50,000 in video may increase sales by more than $500,000 within a year. While quality videos generally provide positive results, money can be wasted on bad videos that yield poor results. Based on the above trends and projections, millions of videos will be created for e-commerce over the coming years. In this case, video will represent a relatively large investment of time and money for retailers. To make sound business decisions, it is important for retailers to understand the tradeoff of the price of production of the video versus the added revenue yield as a result of the video. In general, retailers should avoid investing in bad videos and only invest in good videos, i.e., videos that produce high yields.

Depending on the total annual sales of a product, it may make sense to spend more or less money on a video for the product. For example, if the annual sales are $1,000,000/year, it may make sense to spend up to, for example, $10,000 on a video (if a conversion lift warrants the expenditure). On the other hand, if the annual sales of a product are only $10,000, it clearly would not make sense to spend $10,000 for a video (unless somehow the video could more than double total sales of the product). However, it might be reasonable to spend around $100 for a video on a product with $10,000 in sales. In order to make sound business decisions on expenditures related to video, it is desirable to be able to accurately measure the impact of video on product sales.

The present disclosure provides techniques for measuring the impact of video on product sales, in terms of video conversion lift (VCL), and provides approaches for separating out customer bias (i.e., customers that would have bought with or without video, but happened to watch the video). According to aspects of the present disclosure, measurements and calculations are used to demonstrate how much impact, and thus, how much profit can be expected from a given video. The determined impact can then serve as a foundation for sound business decisions on investing in video. According to one or more embodiments of the present disclosure, a video profit equation for calculating the expected profit from videos is derived.

In a typical e-commerce webpage with video, the number of people that view a video and convert versus the number of people that do not watch the video and convert can be tracked. For example, conversion may correspond to taking a step in a buying funnel (e.g., add-to-cart (ATC), checkout (buy), or signing up for a trial or other product-related interaction). To simplify the math, conversion may be based on ATC (which is the most common first step after watching a video). A standard method of measuring yield increase is to perform a video/no-video test (i.e., an A/B test) where a no-video control group is not provided the option of viewing a video (e.g., typically by removing a video call-to-action (CTA) from the website for, say, fifty percent of website visitors). In one or more embodiments, for the video/no-video test the total ATC events and purchase (buy) events are measured for the customers on each branch of the test. The conversion rates for the video/no-video tests are then compared to calculate the impact of videos.

Conversion rate may then be found by counting how many people converted (added-to-cart or buy conversions) divided by the total number of unique people that had the opportunity to convert. To calculate conversion, all of the unique customers that visit a webpage may be divided into two groups, i.e., a video branch and a non-video branch. The video branch customers are given the opportunity to watch the video by having the video CTA displayed. The non-video branch customers do not have a video CTA displayed on the page. The conversion rate may be defined as: conversion rate=(# of people in the group that converted)/(# of people in the group). The ATC conversion rate on the video branch C_{VB} may be given by:

C_{VB}=A_{VB}/I_{VB}

where A_{VB} is the total number of visitors on the video branch that converted (e.g., added-to-cart) and I_{VB} is the number of page impressions of (unique) website visitors on the video branch.

Similarly, for the non-video branch, the ATC conversion rate for the non-video branch C_{NB} may be given by:

C_{NB}=A_{NB}/I_{NB}

where A_{NB} is the total number of visitors on the no-video branch that converted (e.g., added-to-cart) and I_{NB} is the number of webpage impressions of (unique) website visitors on the no-video branch. It should be appreciated that the conversion rates do not depend on the split ratio of the two branches. For example, a split of visitors to each branch could be 50/50 or the split of visitors to each branch could be 75/25 (or some other ratio), but the conversion rates should be the same (within statistical fluctuations based on sample size).

To compare the two conversion rates, a video branch conversion improvement λ_{VB} may be calculated. The video branch conversion improvement (video branch lift (VBL)) λ_{VB} is given by Equation 1:

λ_{VB}=(C_{VB}−C_{NB})/C_{NB} Equation 1

In general, Equation 1 provides a fair unbiased measure of how much better videos perform, as contrasted with no videos, in a controlled manner. For example, if the conversion rates are equal on both branches, then λ_{VB}=0 (meaning that videos have no impact). As another example, for λ_{VB}=0.1, videos result in ten percent more conversions. It should be appreciated that the ATC conversion rate for the video branch and the ATC conversion rate for the non-video branch should be determined at the same time in order to avoid impact of seasonal fluctuations (i.e., seasonal fluctuations in buying patterns are reflected equally in both groups). Moreover, the approach eliminates any bias that customers may have on each branch (i.e., if customers that watched a video would have bought anyway, the measurement approach eliminates the customer bias).

Results of a number of video/no-video experiments are set forth in Table 1.

TABLE 1

| | | Video | Non-video | Video |
|---|---|---|---|---|
| | | branch | branch | branch lift |
| | | Buy rate | Buy rate | (C_VB-C_NB)/ |
| Client | Category | C_VB | C_NB | C_NB |
| Retailer 8 | Specialty | 1.48% | 1.46% | 1.43% |
| Retailer 13 | Shoes | 1.51% | 1.47% | 2.72% |
| Retailer 20 | Apparel | 3.20% | 3.06% | 4.58% |
| Retailer 28 | Apparel | 0.29% | 0.26% | 11.79% |
| Retailer 30 | Electronics | 0.20% | 0.19% | 9.34% |
| Retailer 32 | Sports | 1.71% | 1.26% | 35.56% |
| Aggregate | Average | 2.72% | 1.28% | 10.90% |

In Table 1, the video branch conversion improvement (or video branch lift) λ_{VB} ranges from about 1.4 to about 35.6 percent, with an average of about 10.9 percent. On average, for the sample set of Table 1 there is about 11 percent more product sold with video than without video. While the results in Table 1 are only for a half-dozen customers, which is not a large sample set, the sample set is large enough to provide some feel for a few items of note. The sample set shows that the overall average video branch conversion improvement is about 11 percent. An 11 percent overall average video branch conversion improvement for a retailer with an average revenue of $1,000,000/year will add on average $110,000/year.

Table 1 shows a wide variance between the lowest lift of 1.4 percent and the highest lift of 35.6 percent. Variance in the apparel category indicates about a 7.2 percent variance between lowest and highest lifts. The variance may be, for example, attributable to customers watching videos at different rates on the different retailer websites, more customer bias for certain categories, or that videos are just not very good on some retailer websites. Typical state-of-the-art testing provides a gross level of information, but no way of drilling down into details to understand the factors involved. In fact, there is no indication in the above numbers that any customer even watched a video. That is, there is no proof of causality of the impact of video at all, as customers were on one branch or the other branch and the results were compared. Conventional approaches provide no process for understanding the factors that affect lift and, thus, provide no information that can be used to improve and optimize video performance with respect to increased sales.

According to one or more embodiments, a mathematical framework (i.e., a video profit equation (VPE)) is disclosed that facilitates a better understanding of performance components and their impact on video profit. To get at the causal components of video, customers may be grouped into different categories based on their observed behavior. For customers that had the opportunity to watch a video (e.g., on a video branch of an experiment or on a website where there is video but no experiment present), behavior of the people that watched the video (viewers) can be tracked and compared to people that had the opportunity to watch the video but did not view the video (non-viewers). To measure the difference in behavior between viewers and non-viewers, the total number of unique visitors that visited a page with a video CTA can be counted as impressions ‘I’ and divided into a viewer group and a non-viewer group, designating each by a subscript of ‘V’ and ‘N’, respectively. According to one embodiment of the present disclosure, the ATC conversion rate for people that viewed the video (viewers) C_{V} is given by:

C_{V}=A_{V}/V

where ‘A_{V}’ is the number of viewers that converted (e.g., added-to-cart), ‘V’ is the number of (unique) customers that viewed the video, V=rI, and ‘r’ is the view rate of the video. Similarly, the ATC rate of non-viewers C_{N} is given by:

C_{N}=A_{N}/I_{N}

where ‘A_{N}’ is number of non-viewers that converted, ‘I_{N}’ is the number of (unique) customers that received impressions of the webpage that contained the video CTA but did not view the video, and I_{N}+V=I or I_{N}=(1−r)I. The total add-to-cart A_{T} may be written as:

A_{T}=IC_{T}=I_{N}C_{N}+VC_{V}=I(1−r)C_{N}+IrC_{V}

Based on the conversion rates for the two groups of visitors, a determination of how well videos are working to increase sales may be undertaken. A determination of how well videos are working to increase sales may be made under the assumption that there is no bias in the groups of visitors. For example, one can first look at the case where customers that are inclined to add-to-cart are equally likely to watch the video versus those that are not. Bias can be measured via a fair video/no-video test (e.g., an A/B test) as illustrated in Table 1. Ignoring customer bias is tantamount to stating that if the video was not present, the customers that watched the video would have added to cart at the same rate as the customers that did not watch the video. Thus, for the number of viewers ‘Ir’ that added to cart at the rate C_{V} one would expect the number of cart adds to be equal to IrC_{N} if there was no video available for the customers to watch. According to an embodiment of the present disclosure, the expected total add-to-cart with no video present A_{E} is given by:

A_{E}=I(1−r)C_{N}+IrC_{N}=IC_{N}

In other words, if there were no videos present (and no bias factored in), the expectation is that customers would add-to-cart at the rate of non-viewers (from the definitions). A forecasted incremental ATC A_{F} may be determined from the difference between the expected ATC A_{E} without video and the actual value with video. According to at least one embodiment, the forecasted incremental ATC A_{F} is given by:

A_{F}=A_{T}−A_{E}

A_{F}=I(1−r)C_{N}+IrC_{V}−[I(1−r)C_{N}+IrC_{N}]

A_{F}=IrC_{V}−IrC_{N}

A_{F}=IrC_{N}L (Equation 2)

where ‘L’ is the video conversion lift (VCL) which is given by:

L=(C_{V}−C_{N})/C_{N} (Equation 3)

As used herein, video conversion lift may be referred to herein as simply ‘lift’ for brevity, where the context is clear. VCL should not be confused with the lift calculation associated with the video branch conversion improvement or VBL defined above, as the two lifts are different by definition and are also different in magnitude (e.g., often by a factor of 10 or more). VCL is used to directly measure how well a video is working and is defined as the increased probability that someone who watches a video will convert. That is, VCL indicates the increased likelihood that a customer that watched a video will convert versus someone that did not watch the video. Thus, if the VCL is 100 percent, then a person that watched the video is twice as likely to convert than a person that did not watch the video. Similarly, a VCL of 200 percent indicates that the person is three times more likely to convert. If the rate of conversion of viewers is the same as non-viewers, VCL is zero and the videos are not contributing to increased conversion.

While VCL is an important indicator in how well a video is performing, the total impact of video on conversion is also determined by how many people watch the video. For example, the VCL for a video might be very high, but if very few people watch the video the overall sales impact or yield may be small. To find the overall sales impact, one should take into account the view rate as well. The forecasted number of people that add-to-cart due to watching a video, or forecasted yield Y_{F} may be derived from:

A_{F}=IC_{N}Y_{F}

where Y_{F}=rL. Given that ‘I’ and C_{N} are values independent of the video, the yield is a direct measure of the forecasted impact of video. A forecasted video profit P_{F} may be derived from:

P_{F}=MIC_{N}Y_{F}α; or

P_{F}=MIC_{N}rLα (Equation 4)

where ‘M’ is the profit margin of the product, α=(1−a), and ‘a’ is the cart abandonment rate. Equation 4 provides the non-bias adjusted forecasted video profit. Equation 4 may be used to calculate the expected profit (ignoring bias) of a product given the measured values of view rate, non-viewer conversion rate, and VCL.

With respect to the margin ‘M’ of a product, there is nothing that a video does that can influence the margin ‘M’, but clearly it is easier to make more profit off of higher margin products. Impressions ‘I’ corresponds to the unique number of visitors that see the call-to-action (CTA) of the video. Normally, one would assume that ‘I’ is just the number of people that come to the product page and are not influenced by video, but this ignores the impact that the video can have on search engine optimization (SEO). Having a video on a page and getting the page indexed can increase the number of visitors significantly. Indexing with video often results in first page search engine results page (SERP) results which can lead to a significant increase in the traffic to a product webpage and increase ‘I’ by perhaps as much as a few percentage points. Since this is top-of-funnel, this translates directly to increased sales by the same fraction. In general, videos dramatically increase first page SERP results. It has been reported that having video on a webpage increases the probability of first page SERP results by fifty-three times.

Ignoring bias, the non-viewer add-to-cart rate C_{N} is the baseline rate of conversion to cart adds for customers that do not watch video (bias changes the baseline and is addressed below). Typical baseline ATC rates range from 10 percent to 30 percent. The video view rate ‘r’ is a factor of the placement of the CTA on the webpage. If the CTA is below the fold, small or otherwise difficult to locate, the view rate ‘r’ is correspondingly low. View rate can be increased by smart merchandising, e.g., moving the CTA to a more prominent location on the page, and can range from as little as one percent for a poorly designed CTA to as high as thirty percent or higher for a very prominent CTA. The VCL ‘L’ is the one and only factor in Equation 4 that directly measures how effective video content is at influencing purchase behavior. VCL measures the increased probability of a customer that watches a video will add-to-cart. Typical values for VCL range from sixty percent or so on the low end to as high as five-hundred percent, meaning that customers are six times more likely to convert if they watch the video (e.g., for an Invodo™ produced video). The abandonment factor α is equal α=(1−a), where ‘a’ is the cart abandonment rate which is normally about the same for people that watch the video versus people that do not watch the video, but there is often a slightly lower abandonment rate (about 5 percent) bonus for people that watch the video.

The yield is a measure of overall impact and is the product of the VCL and the view rate. A forecasted yield of three percent means that the forecasted impact on sales is three percent. A yield of thirty percent provides a thirty percent impact on sales. From all of the above factors, the most important to impact yield are VCL and view rate. One can have an exceptional video in terms of VCL, but if only one percent of customers watch the video the yield is not nearly what it could be if the view rate is in the ten to twenty percent range. For example, if the VCL is three-hundred percent but the view rate is only one percent, the yield is only three percent. The same video with a view rate of ten percent provides a thirty percent impact on sales. It should be appreciated that VCL and view rate need to be high to maximize profit. In general, VCL is the only direct measure of the efficacy of video content. Good video content has very high VCL, whereas bad video content can have poor (even negative) VCL. It should be appreciated that A/B testing of different types of video can help determine which videos produce the best VCL. For example, the impact of having a human presenter in the video versus no presenter may in the video can have a relatively large impact on VCL. While the cost of a presenter is generally greater, most often the added cost is justified with higher VCL. Other factors that influence VCL include the length of the video and the order of presentation of features. It should be appreciated that video evaluation art is rich and deep knowledge of what works for a particular type of product is what differentiates good video performance from bad video performance.

One drawback of Equation 4 is that it does not account for bias. It is expected that some customers that would have purchased anyway are more likely to watch the video than customers not inclined to buy. To measure bias, the results with video from the baseline may be compared with the control case of no video using a video/no-video test. The profit that is generated from a website without video may be used as a baseline. If the number of impressions (unique visitors) to the product webpage per month is ‘I’ and C_{B} denotes the average add-to-cart rate of (baseline) customers, then baseline profit for the non-view branch P_{NB} may be given by:

P_{NB}=MC_{NB}Iα_{NB}

where ‘M’ denotes the profit margin for the product, C_{NB} is the baseline conversion rate for the non-viewer branch, and α_{NB} is the abandonment factor for the non-viewer branch.

For example, if 1,000 visitors come to the product page in one month, 10 percent add-to-cart, and 70 percent abandon the cart, then the total number of units sold of that product is 30. If the profit margin is $100/product, then the baseline profit for that product is P_{NB}=$3,000/month. To find the impact of video, we measure the performance against the baseline in a randomized video/no-video test over the same time interval. Let A_{VB} denote the number of units added-to-cart on the test video branch and A_{NB} denote the total ATC rate of customers on the baseline no-video branch. The incremental number of units added to cart on the video test branch A_{I} is given by:

A_{I}=A_{VB}−A_{NB}=I(C_{VB}−C_{NB})

The incremental profit P_{I} is the actual yield of incremental sales due to video multiplied by the margin of each product sold influenced by the video may be given by:

P_{I}=MIC_{NB}Yₐα_{NB} (Equation 5)

where Yₐ is the actual rate of incremental sales due to the video and is given by:

Yₐ=(C_{VB}/C_{NB})−1=(C_{VB}−C_{NB})/C_{NB}=λ_{VB}

Equation 5 can be used to measure video profit. However, it should be pointed out that Equation 5 does not capture everything. For example, Equation 5 does not capture the impact that videos can have on reducing returned items. Nor does Equation 5 capture the overall impact that videos may have on a brand or adequately capture the impact of video on SEO. Moreover, in a “click-and-mortar” business, Equation 5 does not capture the true impact video has on buyers that do research online then purchase in the store. Nevertheless, Equation 5 is a good fair test of the impact of video on online sales.

To derive actual yield Yₐ, values should be measured in a fair test over a same time period. It would not be fair, for example, to test the amount purchased during the holiday season with the amount purchased prior to the holiday season. Rather, a fair video/no-video test with, e.g., a 50/50 split, should be performed over the same time interval. Given that performing a test can decrease sales, customers may opt to not perform tests (and many companies balk at testing during peak sales seasons) and select a less intrusive approach to estimating incremental profit due to video. For example, incremental profit due to video may be estimated by calculating VCL of a video and a gain factor that accounts for customer bias. In this case, an incremental video profit equation can be written as:

P_{I}=MIC_{NB}Yₐα_{NB}=MIγC_{N}Y_{F}α_{VB} (Equation 6)

where Y_{F} is the forecasted yield and γ is the gain (i.e., an adjustment that accounts for customer bias). The gain γ can be written as:

γ=MIγC_{N}Y_{F}α_{NB}/MIC_{NB}Yₐα_{VB} (Equation 7)

The incremental video profit equation can then be written as:

P_{I}=MIγC_{N}rLα_{VB} (Equation 8)

Examining the terms of Equation 8 (i.e., the video profit equation) it should be apparent that Equation 8 only differs from Equation 4 (i.e., the forecasted video profit equation) by the gain γ. Thus, gain γ accounts for bias and adjusts the forecasted profit to match the measured profit. Equation 8 is particularly useful as the equation decomposes the profit into individual terms that can be independently measured. Moreover, Equation 8 provides focus on how to improve overall performance. As previously stated, video conversion lift ‘L’ is the only term that is a direct measure of the efficacy of a video. Equation 8 is particularly useful in that it can be used to perform different A/B tests with different videos to optimize performance (i.e., increase profit). Testing one video versus another video, all else being equal, the only item in Equation 8 that will change is the video conversion lift ‘L’. The gain γ, by definition, does not change as gain measures the bias of people that would have bought anyway and that population is invariant based on the video used.

Performing a video/no-video test (i.e., an A/B test) is expensive in that because videos increase profit every time you perform one of the experiments profit is reduced. By employing Equation 8 to measure profit, once a statistically significant measure of gain γ is established, no further video/no-video experiments are required and focus can be shifted to other parameters to achieve better videos performance.

Referring back to Table 1, there are many factors that can impact overall video performance. One of the more important factors is the view rate ‘r’. The view rate is not a function of the video, but a function of the placement of the CTA on the page. If the CTA is “below the fold”, or otherwise not prominent, then the view rate can be very small. Rather than focusing on better videos, a retailer may be encouraged to use “smart merchandising” to increase the view rate.

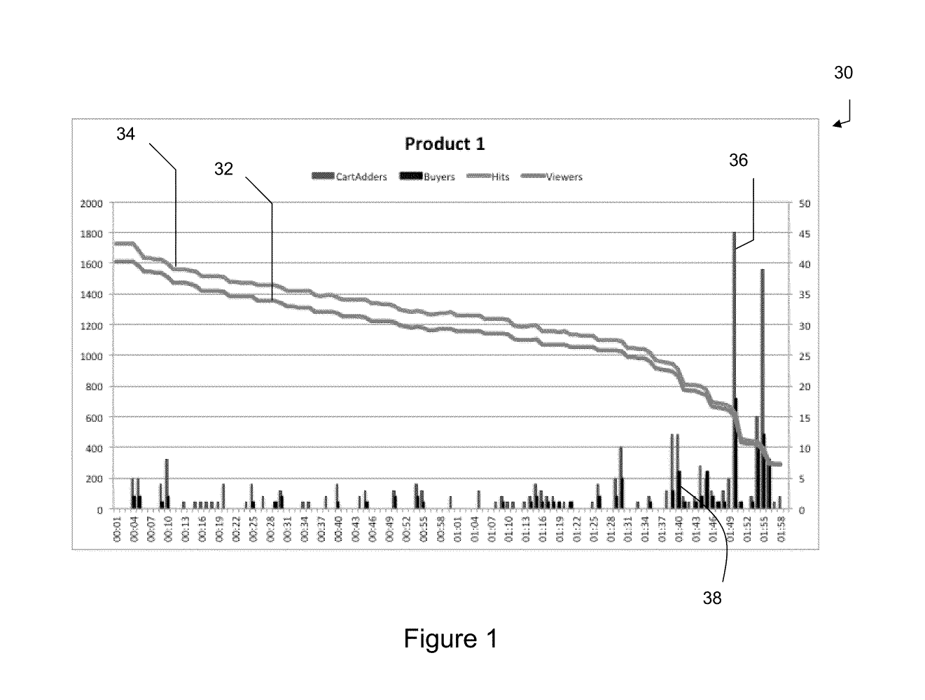

According to various aspects of the present disclosure, the performance of video may be optimized by: picking a category (or several categories) of products to produce videos for a retail site; performing a video/no-video (A/B) experiment to obtain a gain factor for each category; examining the results and comparing the results to average results (presented below); using “smart merchandising” to increase the view rate; and using A/B tests on other videos within a category to increase VCL. In general, qualitative and quantitative information can be used in the process to produce more effective videos. Examples of suggested A/B testing with different videos include: voiceover versus presenter, wherein a live presenter is used rather than just video of the product; documentary versus conversational style (style and tone of presenter); short versus long videos; pets or no pets; children or no children; feature order in the video; on-site video versus in-studio video; white-screen versus set video; including motion graphics in the video versus no motion graphics in the video; and including in-video shopping or calls-to-action within the video versus no calls-to-action. The above tests, as well as other A/B tests, can be performed and using Equation 8 only the VCL of each video needs to be compared to determine which video has better performance. In addition, behavior of the customers that are watching the video may be examined to gain further insights into viewing and purchase behavior, an example of which is shown in FIG. 1.

With reference to FIG. 1, an example graph 30 of a watch metrics report for a video is illustrated. The report shows the number of unique viewers line 32 that viewed a video to a certain time in the video (x-axis), and the number of frames viewed line 34. As such, if some viewers viewed more than once, the viewers in the line 34. The cart add events are shown in line 36 and purchases in line 38. The watch metrics report includes a wealth of information regarding customer viewing and buying patterns. The information, along with the analytic information from the profit equation combined with ratings and comments (qualitative information), can be used to optimize the performance of a video. For example, the drop-off in view rate at the end of the video comes from “boilerplate” company information that has little to do with the product. An A/B test can be performed in this example with a shorter video.

To understand how different retailers perform in different categories, results of over thirty companies were measured with different categories of products. The results are presented below in Table 2. The results are useful in understanding performance by comparing measured results of a new customer to industry averages. The results are compiled from different studies and experiments over varying timeframes from 2011 to 2012. Typically, each of the data sets in the study included over 90 days of data for the video/no-video results and 30-60 days of data for the A/B test results.

TABLE 2

| | | | Avg. Conf |
|---|---|---|---|
| | | | Interval |
| Parameter | Avg. | STDEV | (95%) |
| Cart Add Lift | 209% | 175% | 65.2% |
| View rate | 9.0% | 8.6% | 3.2% |
| Forecasted Yield: Non bias | 19.2% | 30% | 11.0% |
| adjusted incremental ATC | | | |
| via video (ATC Yield) | | | |
| Non-viewer ATC rate CN | 11.9% | 20% | 7.3% |
| Viewer ATC rate CV | 32.1% | 49% | 18.1% |
| Total (viewer/ | 14.4% | 22% | 8.2% |
| nonviewer ATC rate) CVB | | | |
| Non-viewer exp. | 7.7% | 7.0% | 5.8% |
| Branch ATC rate CNB* | | | |
| Measured ATC delta | 7.18% | 11% | 8.8% |
| (CVB-CNB)/CNB | | | |
| ATC Gamma | 72% | 18% | 16.9% |
| Purchase Lift | 289% | 236% | 95.2% |
| Non-bias adjusted incremental | 26.1% | 15% | 6.1% |
| Buys via video (Forecasted Yield) | | | |
| Non-viewer Buy Rate BN | 2.49% | 5.7% | 2.3% |
| Viewer Buy Rate BV | 6.39% | 14% | 5.7% |
| Total buy rate BVB | 2.72% | 6.0% | 2.4% |
| Non-viewer abandon rate | 79.45% | 16% | 6.5% |
| viewer abandon rate | 75.15% | 19% | 7.7% |
| Total Abandon Rate | 78.80% | 16% | 6.4% |
| Video branch abandon rate | | | |
| Non-video branch buy rate * | 1.28% | 1% | 1.1% |
| Measured ATC delta | 10.90% | 13% | 13.3% |
| (BVB-CNB)/CNB | | | |
| Buy Gamma | 71.79% | 16% | 16.5% |

With respect to Table 2, tabulated parameter averages for 32 retailer datasets are illustrated. The average values can be used in the profit equation to help predict performance and compare against industry averages. The standard deviation (SDEV) of the dataset is provided as well as the 95 percent confidence interval for the average calculation. Averages for these values were calculated only for video/no-video experiments (7 for ATC and 6 for purchase). From Table 2 a number conclusion can be reached. For example, people that watch video are 209 percent more likely on average to add to cart than people that do not watch video (ignoring bias).

From Table 2, the average view rate of videos is 9 percent and the average increase in ATC due to videos is 19 percent (video ATC yield, ignoring bias). As illustrated by Table 2, average gamma (gain factor) is 71 percent, meaning that, on average, the actual measured yield will be seventy-two percent of the forecasted yield. In other words, bias decreases the forecasted yield by about 28 percent. From Table 2, people that watch the video are on average 289 percent more likely to purchase (ignoring bias) and the purchase gamma is also around 72 percent. People that watch the video are on average about 5 percent less likely to abandon their cart (5 percent more likely to complete a purchase). The average purchase increase due to videos is 26 percent (video buy yield, ignoring bias). Taking bias into account, the expected ATC and buy yield are calculated as 13.7 percent and 18.7 percent, respectively (72 percent times the yields), to get a bias-adjusted result. In general, one would expect the measured results to be close to this on average. These results are averages over a relatively large population, but it is worthwhile to note that there is significant variance in the yield. Much of the variance in yield comes from the wide range of view rates. Additionally, there is variance among the categories of retail products.

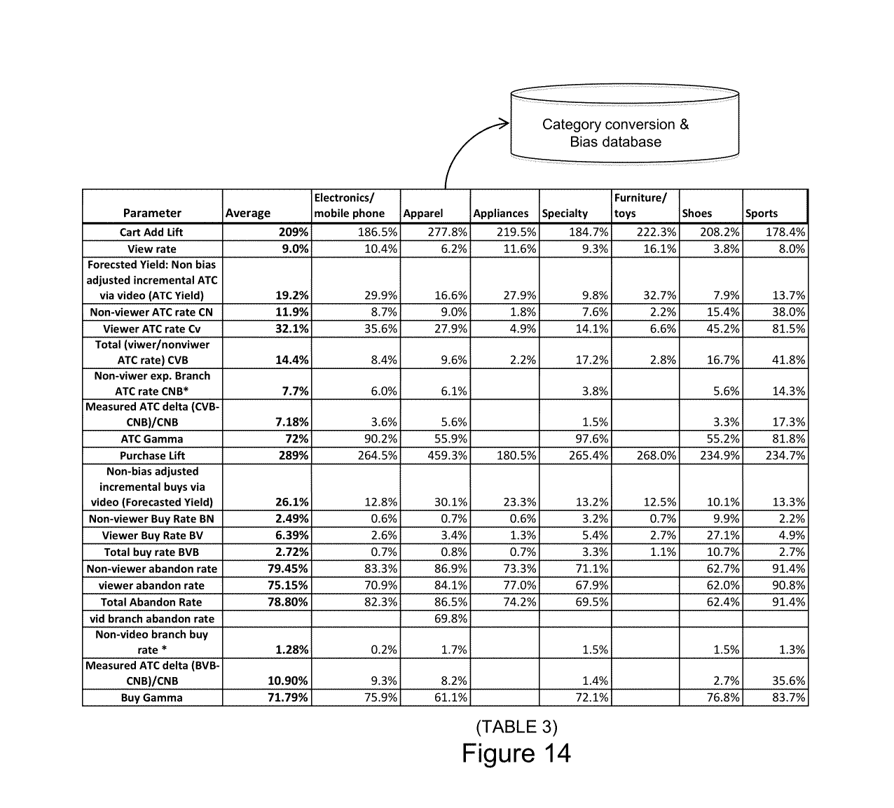

With reference to FIG. 14, Table 3, which includes values for a number of different categories, is illustrated. Table 3 provides comparison of parameters for the various categories of retail products. In Table 3, blank cells indicate no data available and ‘*’ indicates that the A/B test was only performed over a subset of data available. By examining Table 3, reasons for why there is a large variance in the measured video/no-video yield improvement for the retailers may be determined. In the Table 3, ‘Furniture/Toys’ has a VCL comparable to ‘Shoes’, but the view rate of ‘Shoes’ is less than one-fourth the view rate of ‘Furniture/Toys’. Correspondingly, the forecasted ATC yield impact is about one-fourth. Even if everything else is equal, one would expect a much lower yield impact from a test. This is an excellent example of where a recommendation to the ‘Shoe’ retailers would be to increase the views of video on the pages by making the CTA more prominent, as the videos seem to be fine.

Actual yield ranges from about 1 percent on the low end to as high as 35 percent. A one percent yield may not seem like a lot, but if you have a large number of customers coming to your website the impact on sales can be appreciable. In one customer case, a one percent yield translated to over $250,000 in annual sales due to the large number of customers coming to the website. Thus, a small yield times a large volume translates to an excellent profit increase. Similarly a large yield with a smaller volume on a high-margin product can translate into a high profit. As shown in Table 3, the low-end results are usually due to low view rates. For customers with reasonable CTAs, the low-end yield value is three percent. To calculate the expected monthly profit for adding video to your product pages, the ranges will be in the low/high range of 3 percent to 30 percent times the margin times the visitors/month.

With reference to Table 4, examples of expected monthly profit for low and high estimates of yield and varying visitors to the product page/month are illustrated.

| | | Low (3%) | Expected | High (30%) |
|---|---|---|---|---|
| | | profit/mo | (average) | profit/mo |
| Margin | Visitors/mo/page | estimate | profit/mo | estimate |
| $1,000 | 10,000 | $300,000 | $1,800,000 | $3,000,000 |
| $100 | 10,000 | $30,000 | $180,000 | $300,000 |
| $100 | 1,000 | $3,000 | $18,000 | $30,000 |
| $10 | 100,000 | $30,000 | $180,000 | $300,000 |
| $10 | 1,000 | $300 | $1,800 | $3,000 |

In Table 4, profit range is relatively large and the actual yield varies significantly based on a number of important factors discussed above. Nevertheless, Table 4 provides guidance on what can be expected from a profit standpoint. Expected profit can help focus in on which products to choose for video campaigns. In general, video campaigns should have a relatively high ROI and pay for themselves in a few months. Typically, focusing on the top 20 percent of margin contribution of products on a website is a good rule-of-thumb. It should be pointed out that some videos may even have a negative impact, and the impact may be different on different segments of the population, as detailed here: http://searchengineland.com/the-ecommerce-product-video-that-increases-revenue-per-visit-133565. The link points out the importance of good video content. In general, not all content works the same and different types of videos can provide very different results. According to the present disclosure, the Video profit equation is employed to dissect the impact of the videos on profit and take measurements of what converts to the best profit. The derived information is then fed back into the content production process to make the content even more effective.

In general, to calculate the actual yield one must perform a fair video/no-video test. Performing video/no-video tests are straightforward with the appropriate testing software. However, once the gain is well established for a product category, video/no-video tests are often not needed all the time (although periodic checks are recommended to track gain drift). No tracking gain frees up a testing engine to concentrate on other factors that improve the performance without significantly decreasing the value of video on a website. It should be noted that every time a 50/50 split video/no-video test is performed, the available profit increase from video is being decreased by 50 percent.

One of the other important factors in the video profit equation (Equation 8) is the impressions ‘I’, which is the total number of unique visitors to a product page. Videos have an excellent impact on the impressions if the videos result in indexing of videos on the product pages. According to an aspect of the present disclosure, dynamic tags may be inject into product pages via an InPlayer. In general, injecting dynamic tags in product pages in conjunction with video site map submission has shown excellent results for product page indexing with high-ranking SERP results. As noted above, a report indicated a 53 times higher likelihood of first page search results with video than without. A more reasonable and realistic impact on top-of-funnel is probably in the 1 percent to 10 percent range which would likely translate into a similar increase in sales. However, this factor is not measured in a video/no-video A/B test, as if a page is indexed with a video on the page there is no way to factor that out in a standard video/no-video test. In this case, the impact of video with SEO and search engine indexing will usually be greater than what is measured in a standard video/no-video test.

Aspects of the present disclosure have provided a detailed mathematical formalism on how to measure the impact of videos on e-commerce sales. The disclosed techniques go beyond the standard video/no-video testing to break down the components that impact profit so as to understand and optimize the performance of video. According to the disclosure, the factors of lift, view rate, and bias have been demonstrated as being relatively important in increasing profit. In general, the overall ROI shows that videos work extremely well and will become an increasingly important part of e-commerce. In fact, videos typically provide an ROI in only a few months. There are very few investments in e-commerce that can return $500,000 for a $50,000 investment, but that is commonplace with videos. As the ROI of videos becomes more widely accepted, the next major problem in the e-commerce industry will be how to produce a large number of effective videos for large retail sites. Effectiveness of the videos may be measured in terms of the video conversion lift, and as more A/B tests are performed it is anticipated that the disclosed video profit equation will provide an invaluable tool in developing and optimizing video strategy.

To optimize the performance of video, a video lift calculation may be performed for each video, with the lift for each video compared to determine which video is more effective. As stated above, there are many things that can impact the performance of a video. The content of videos is of paramount importance, yet is notoriously difficult to quantify. Just as there may be hit performances at the theater, the creativity, talent, editing and production of the performance is just as important as the script. By measuring lift on different videos, one can discern what works and what does not work for different targeted audiences. In a standard A/B test, video ‘A’ is tested versus video ‘B’ and video lift for each video is measured to determine which video is better. As noted above, examples of suggested A/B testing with different videos include: voiceover versus presenter, wherein a live presenter is used rather than just video of the product; documentary versus conversational style (style and tone of presenter); short versus long videos; pets or no pets; children or no children; feature order in the video; on-site video versus in-studio video; white-screen versus set video; motion graphics in video versus no motion graphics; and in-video shopping or calls-to-action within the video versus no calls-to-action.

Behavior can be tracked from one video to another video, as well as sub-segments of the viewers, to determine an effectiveness of various videos. For example, one can test whether a shorter video may work better for a mobile platform versus a longer video. As another example, one can test female presenters versus male presenters and test which works better for a female shopper. As yet another example, one may test a young or old presenter for different age-segmented targets. Other items that can be targeted based on personalized information include: the use of different accents on actors in different videos based on geographic location information; the use of different race of actors in videos based on known ethnicity; the use of different actors based on income; the use of motion graphics based on age or sex; and different videos based on user agent, mobile, or browser.

The video production process is also complex and involves many different elements. The elements that can be tracked in a database and optimized to produce the most profit include: script writer; talent (actors/type of actor); producer; set; and editor. The video can be placed on an e-commerce webpage using a common scripting language, e.g., Javascript. The Javascript can be configured to receive personalized information from a personalized information database or other source, such as using an Internet protocol (IP) or known geographic location information of the user, using the user-agent information to determine if the customer is on a mobile platform or what type of browser. The video can be displayed in a video player.

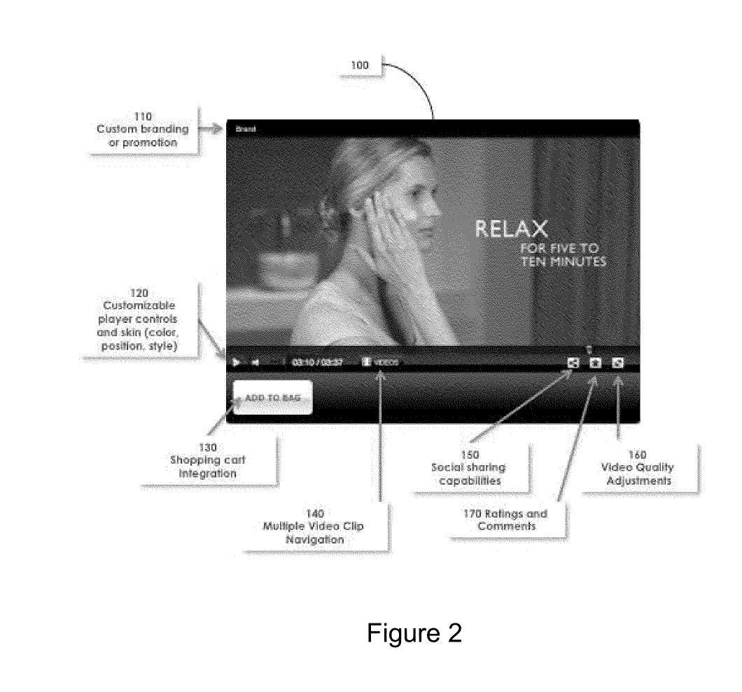

An exemplary video player 100 is illustrated in FIG. 2. Video player 100 may include: custom branding or promotion 110, customizable player controls and skin (color, position, and style) 120, shopping cart integration 130, multiple video clip navigation 140, social sharing capabilities 150, video quality adjustments 160, and options, e.g., ratings and comments 170. Ratings and comments from customers can be fed back into a production database and production process to optimize the performance of the video.

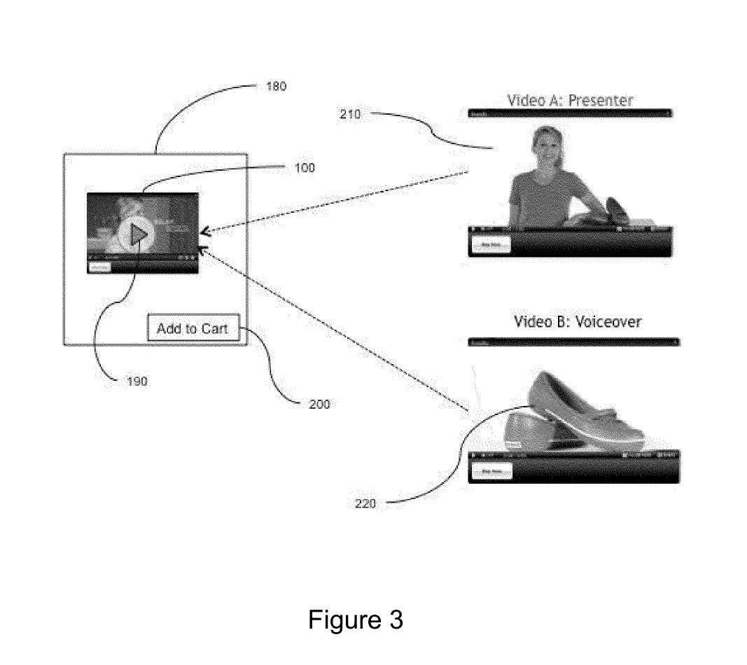

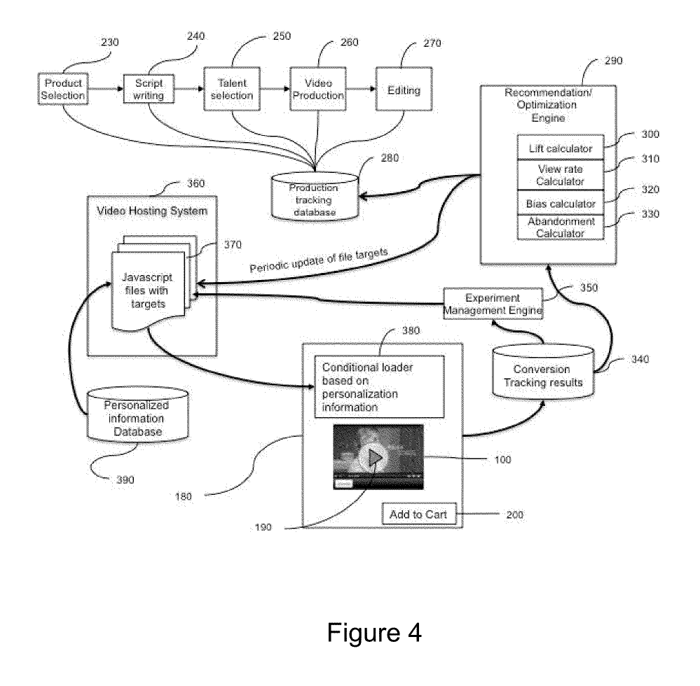

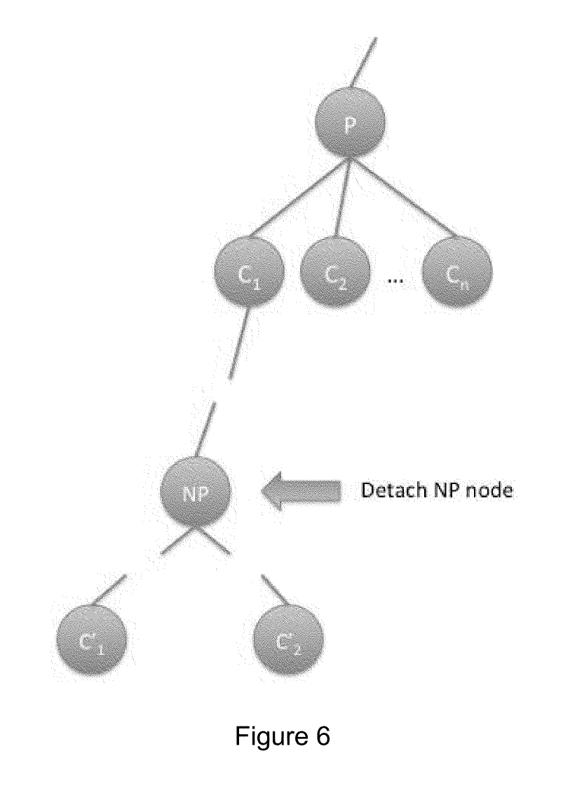

Different videos can be tested within the video player 100 on a webpage 180 in response to call-to-action 190, as is shown in FIG. 3. In FIG. 3, video ‘A’ (which includes a presenter 210) or video ‘B’ (which includes voiceover) may be presented in the video player 100. Add-to-cart 200 may be employed by a viewer to purchase a product in response to video ‘A’ or ‘B’. The video player 100 may be incorporated into a full system as is illustrated in FIG. 6. In FIG. 4, the components of the video player 100, embedded in a webpage 180, are shown with an add-to-cart button 200. The player 100 is loaded with Javascript or some other convenient language (such as, Ajax, php, etc.) into the webpage 180 which allows for conditional processing based on personalized information. A player call-to-action button 190 can be managed (to be shown or not shown) based on experiment management engine 350 rules that are put into Javascript files 370 on video hosting system 360. Javascript loader 380 and player 100 are configured to dynamically run experiments based on the personalization information either from browser/user agent/network/geographic information that is available and/or from personalization information database 390.

In addition the player 100 and the Javascript loader 380 are configured to track customer behavior (such as, page views, video views and conversion events, e.g., add-to-cart 200 and/or purchase events (not shown)). The events are sent to a conversion tracking results database 340 and the calculations of the data are performed in recommendation/optimization engine 290. Specifically, lift 300, view rate 310, bias 320, and abandonment 330 are some of the performance indicators that are calculated. The recommendation/optimization engine 290 is then configured to change the Javascript files (with loading targets) 370 to optimize the performance (profit) of the video. Different videos are produced by different steps in the production process including (but not limited to) product selection 230, script writing 240, talent selection 250, production 260, and editing 270. All of these production steps are tracked in production database 280 and the recommendation/optimization engine 290 is configured to feedback credit for each of the different components. For example, if there are two different script writers working on two different videos in an A/B test, the video with the higher video lift will credit the script writer that worked on that video. The credit may then be used as a preference for that script writer for future video production. A similar mechanism for optimization can be performed on each of the components of production.

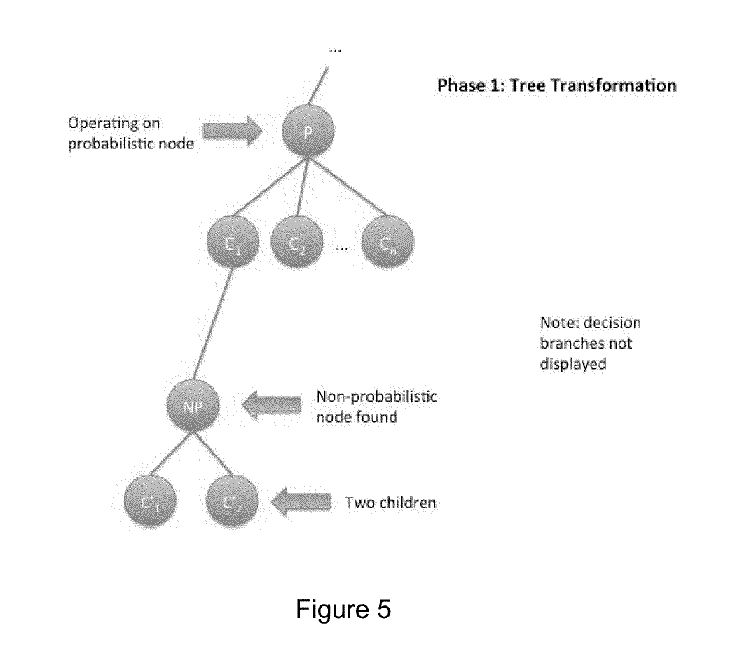

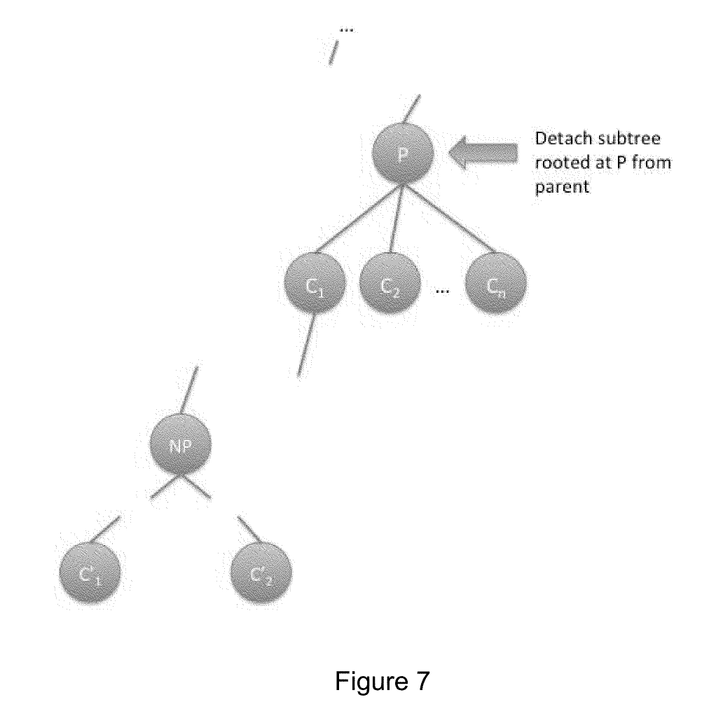

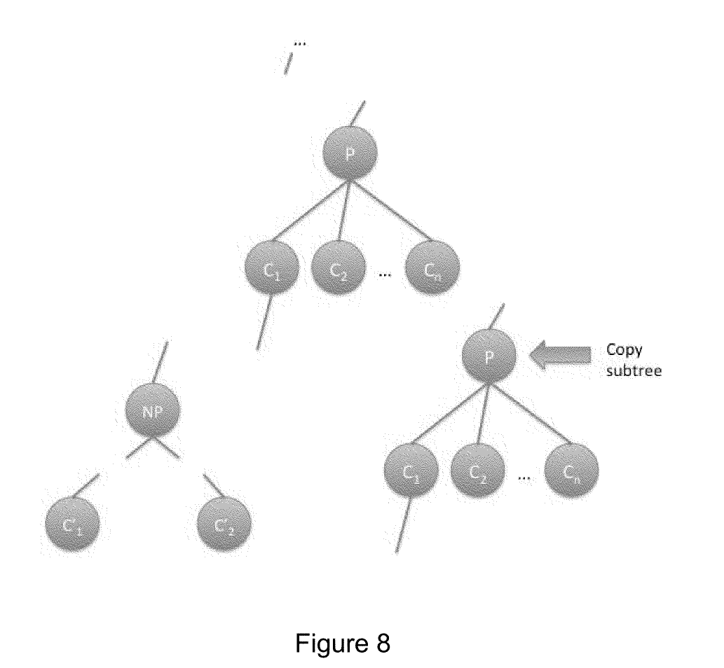

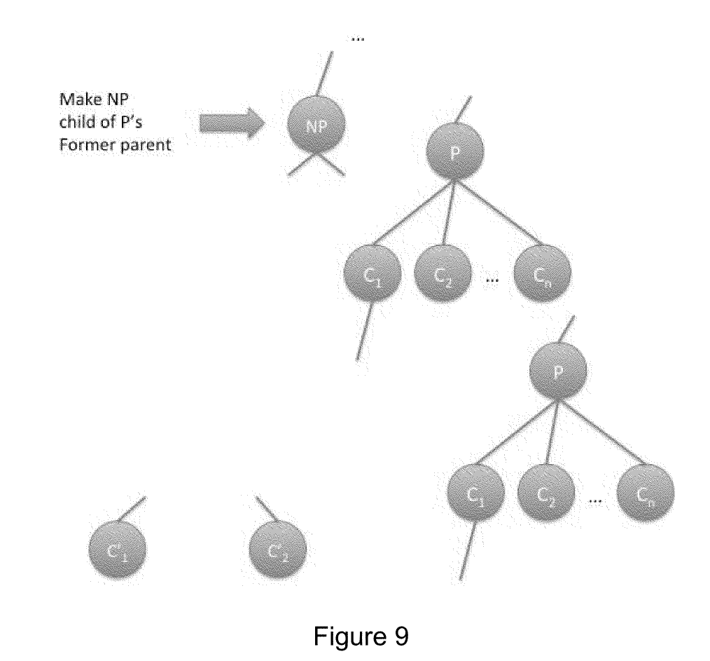

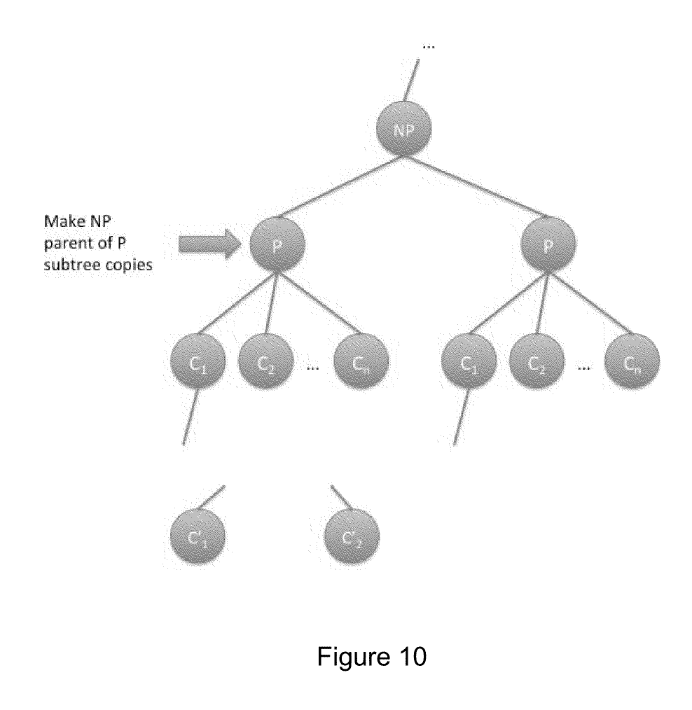

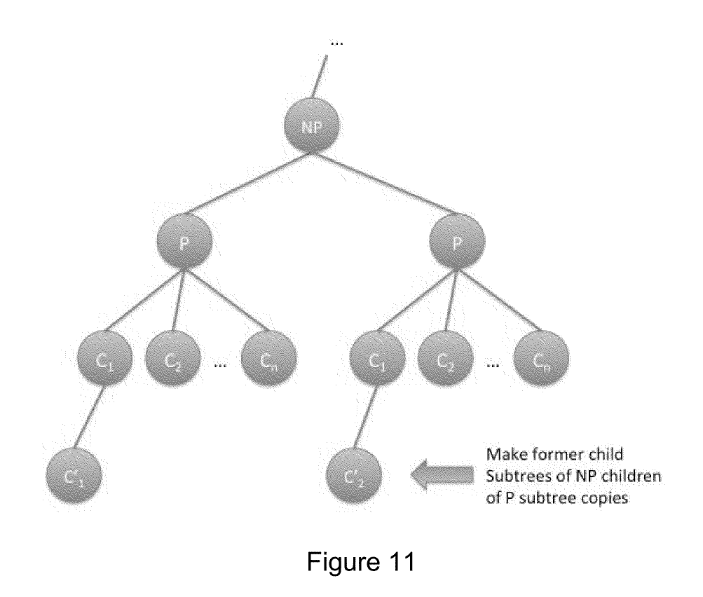

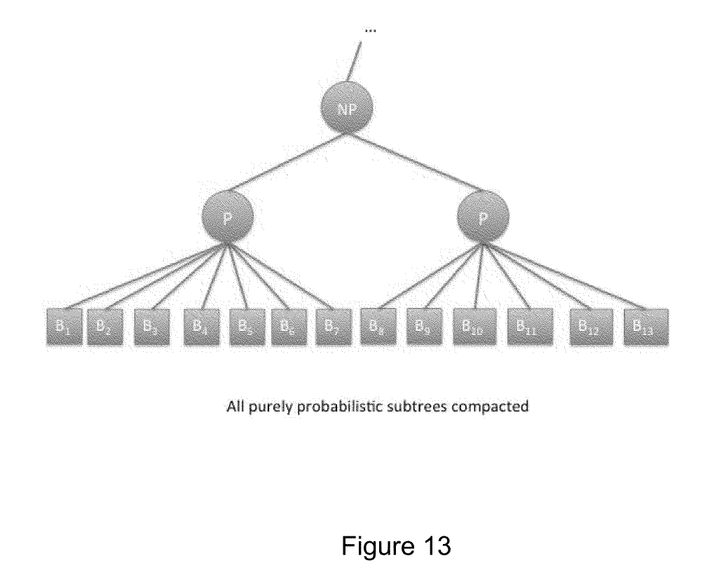

With reference to FIGS. 5-13, a process is illustrated for transforming a data structure representing a decision tree of arbitrary complexity into one that is more compact and readily traversed at decision time. Any sequence of decisions can be represented as a tree, with nodes representing each decision to be made, and paths leading from one decision node to the next, ultimately leading to final decision branches. The outcome of some decisions are based on contextual or environmental information, while the outcomes of other decisions are based on probability of a random occurrence, such as whether a generated random number is greater or less than a certain value. The process transforms the tree in such a way that all contextual and environmental decisions can be made first, and then a single probabilistic decision can be determined, thus reducing the number of decisions that are required to be processed.

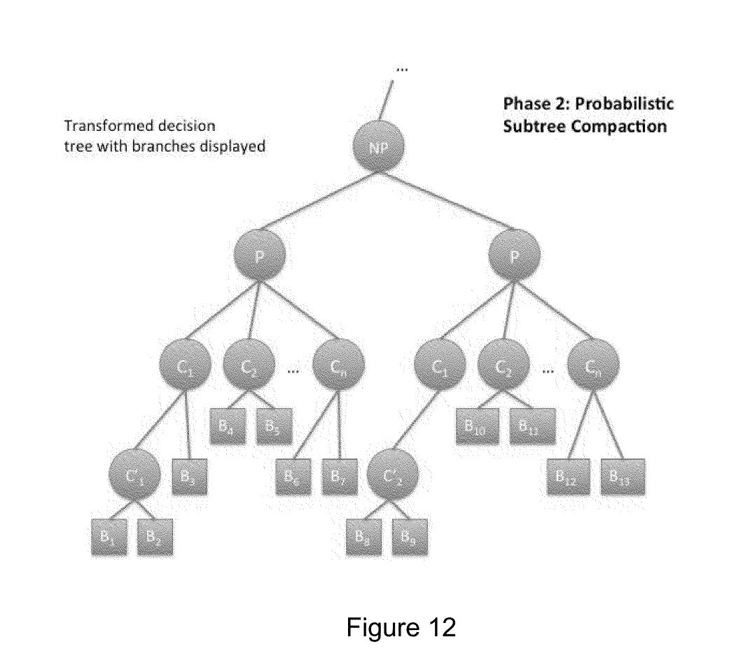

The process comprises two phases of processing: a tree transformation phase (phase 1, see FIG. 5); and a subtree compaction phase (phase 2, see FIG. 12). The tree transformation phase proceeds by performing an operation comprising examining a node in the tree and performing a series of zero or more transformations to the subtree(s) underneath it, and then selecting one of the adjacent nodes to perform the same operation again in a recursive manner. The operation performed on a node consists of first examining the node. If the node represents a non-probabilistic decision (e.g., a contextually or environmentally based decision), then the process traverses the links to each child node beneath it in turn (in no deterministic order) and performing the same operation. If the node represents a probabilistic decision, then the operation prescribes a depth-first search down each of the child branches to find a non-probabilistic node.

If a non-probabilistic node is found, the search is halted. The non-probabilistic node is detached from its parent node, as is the probabilistic node currently being operated on. The non-probabilistic node is also detached from each of its child nodes. The non-probabilistic node is then attached to the (former) parent of the probabilistic node being operated on. The subtree rooted at the probabilistic node is duplicated as many times as the non-probabilistic node had children (which are all now detached subtrees). Each duplicated subtree rooted at the probabilistic node is made a child of the non-probabilistic node such that the same decision criteria that would have led to traversing the branch to the original child will now lead to the (possibly copy of the) probabilistic node, and the corresponding original child node is made the child of the parent node from which the non-probabilistic node was originally detached.

This final step is repeated for each detached copy of the subtree rooted at the probabilistic node (copy) that is being operated on, and the corresponding detached subtree rooted at the node formerly a child of the non-probabilistic node until all copied subtrees and detached subtrees rooted at former children of the non-probabilistic node are all re-connected, resulting in a single tree with no detached nodes or subtrees. Once all subtrees are re-connected, the operating is repeated, beginning at the non-probabilistic node that was just re-inserted into the decision tree, repeating the process until all nodes in the tree have been traversed, at which point there are no probabilistic nodes higher in the tree than a non-probabilistic node. Every decision tree has a single root node, representing the first decision to be made. The initial operation of phase one begins at that node.

The second phase consists of compacting all purely probabilistic subtrees. Each probabilistic node represents a decision with two or more outcomes. Each outcome has a fixed probability between zero and one. Each outcome may lead to another probabilistic decision node with its own set of probable outcomes. These children may be compacted into the parent by replacing the link to the child in the tree with as many links as there are possible outcomes of the child. The probabilities assigned to the new links are equal to the product of the original probability of the outcome leading to the child with each of the probabilities of the outcomes of the child decision, respectively. This process is repeated recursively until all probabilistic decision nodes have no decision node children, and every outcome links to a final decision branch.

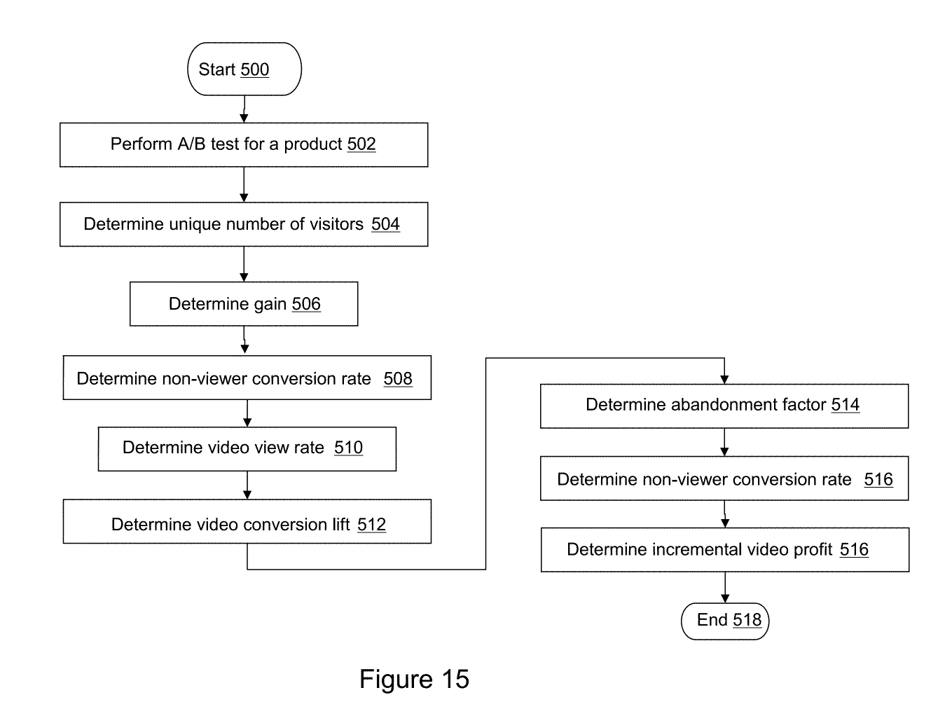

With reference to FIG. 15, a flowchart of a process for measuring video profit, according to an embodiment of the present invention, is illustrated. The process is initiated in block 500, at which point control transfers to block 502 where an A/B test for a product is performed (e.g., by experiment management engine 350) while monitoring for customer conversion. In this case, at least one of ‘A’ and ‘B’ correspond to video. Next, in block 504, a unique number of visitors to a product webpage that viewed a call-to-action for a video of the product is determined based on the test (e.g., by recommendation/optimization engine 290). Then, in block 506, a gain that accounts for customer bias is determined based on the test (e.g., by recommendation/optimization engine 290).

Next, in block 508, a non-viewer conversion rate is determined based on the test (e.g., by recommendation/optimization engine 290). Then, in block 510, a video view rate is determined based on the test (e.g., by recommendation/optimization engine 290). Next, in block 512, a video conversion lift is determined based on the test (e.g., by recommendation/optimization engine 290). Then, in block 514, an abandonment factor is determined based on the test (e.g., by recommendation/optimization engine 290). In block 516, an incremental video profit for the product is determined based on the unique number of visitors, the gain, the non-viewer conversion rate, the video view rate, the video conversion lift, and the abandonment factor (e.g., by recommendation/optimization engine 290). Following block 516, control transfers to block 518 where the process terminates.

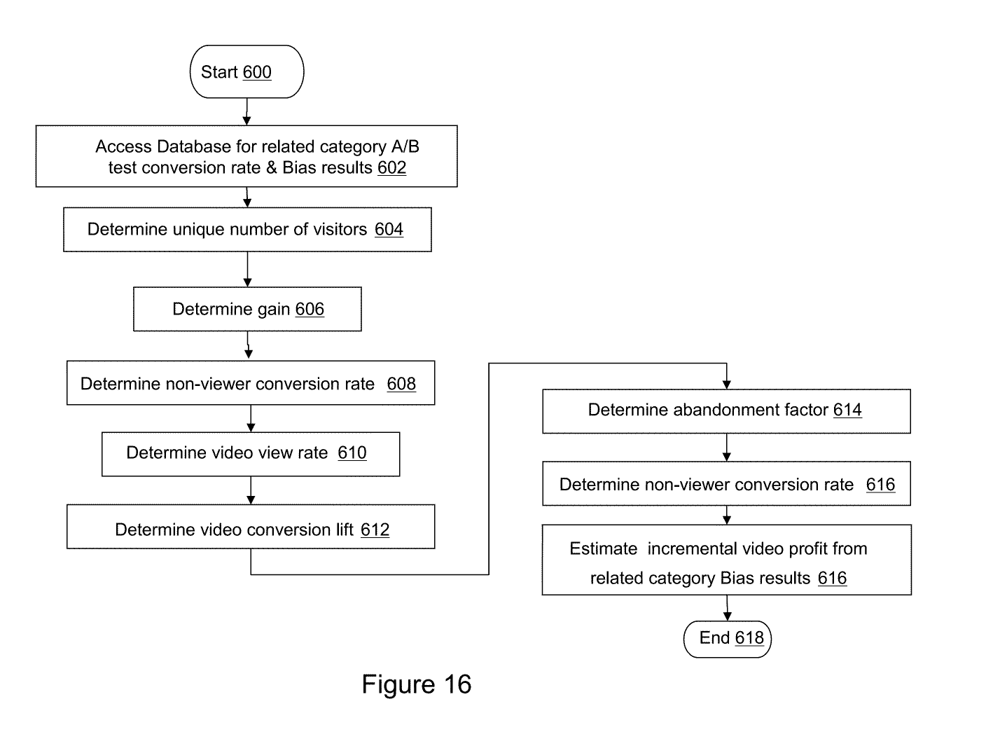

With reference to FIG. 16, a process (executed on a data processing system) for estimating video profit via a database of statistical values for each category of product without requiring an A/B test, according to an embodiment of the present invention, is illustrated. The process is initiated in block 600, at which point control transfers to block 602 where a database is accessed for a related category A/B test conversion rate and bias results for a product. Next, in block 604, a unique number of visitors to a product webpage that viewed a call-to-action for a video of the product is determined. Then, in block 606, a gain that accounts for customer bias is determined.

Next, in block 608, a non-viewer conversion rate is determined. Then, in block 610, a video view rate is determined. Next, in block 612, a video conversion lift is determined. Then, in block 614, an abandonment factor is determined. Next, in block 616 a non-view conversion rate is determined. Then, in block 616, an incremental video profit is estimated from related category bias results. Following block 616, control transfers to block 618 where the process terminates. The main idea behind the process depicted in FIG. 16 is that once a database of a category of a company's products are established, A/B testing does not always have to be performed to determine an estimated profit for a product. That is, an estimated profit for a product can be derived using the video profit equation with average category results.

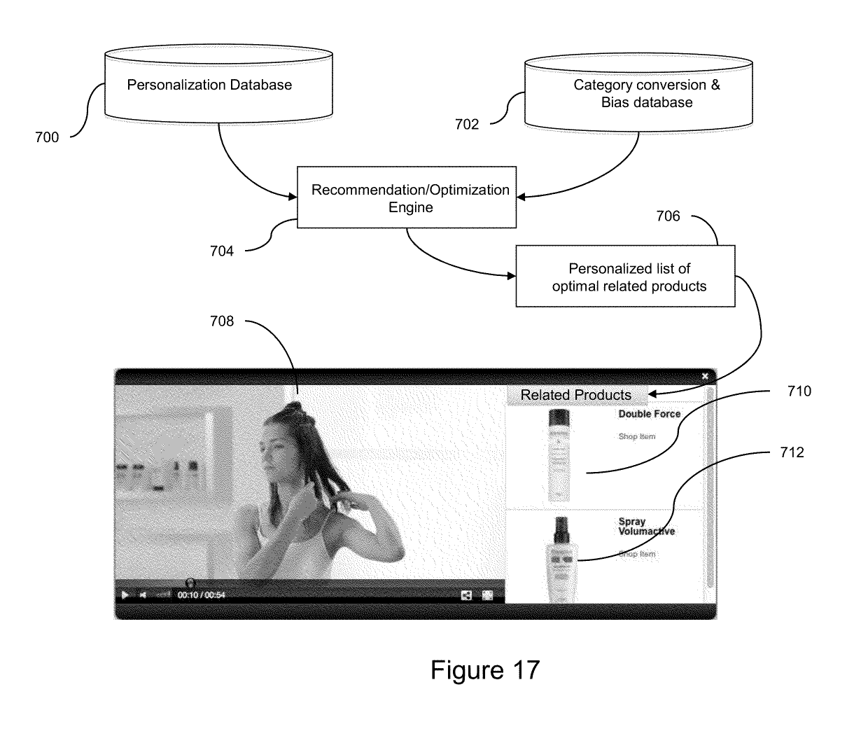

With reference to FIG. 17, an exemplary video player that is configured to include links to offer different products that are determined by a recommendation/optimization engine that accesses a database product category information and/or personalized information, according to an embodiment of the present invention, is illustrated. As is shown, a recommendation/optimization engine 704 receives information from personalization database 700 and category conversion and bias database 702. Based on the information received from personalization database 700 and category conversion and bias database 702, recommendation/optimization engine 704 provides a personalized list of optimal related products 706 of which two product links 710 and 712 are displayed on video player 708. The main idea behind the embodiment of FIG. 17 is that the video player experience can be personalized with personalization/product category information databases via an optimization engine that optimizes estimated profit.

Accordingly, techniques have been disclosed herein that advantageously optimize the targeting of video content using one or more disclosed video profit equations.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included with the scope of the present invention. Any benefits, advantages, or solution to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A method of measuring a video profit for a product, comprising:
performing, using a data processing system, an A/B test for a product while monitoring for customer conversion, wherein at least one of ‘A’ and ‘B’ correspond to video;
determining, using the data processing system, a unique number of visitors to a product webpage that viewed a call-to-action for a video of the product based on the test;
determining, using the data processing system, a gain that accounts for customer bias based on the test;
determining, using the data processing system, a non-viewer conversion rate based on the test;
determining, using the data processing system, a video view rate based on the test;
determining, using the data processing system, a video conversion lift based on the test;
determining, using the data processing system, an abandonment factor based on the test; and
determining, using the data processing system, an incremental video profit for the product based on the unique number of visitors, the gain, the non-viewer conversion rate, the video view rate, the video conversion lift, and the abandonment factor.

2. The method of claim 1, further comprising:
determining a profit margin for the product, wherein the determining, using the data processing system, an incremental video profit further comprises determining the incremental video profit based on the profit margin.

3. The method of claim 2, wherein the incremental video profit P_{I} for the product is given by:
P_{I}=MIγC_{N}rLα_{VB}
where ‘M’ is the profit margin for the product, impressions ‘I’ is the unique number of visitors that viewed a call-to-action for a video of the product, γ is the gain, C_{N} is the non-viewer conversion rate, ‘r’ is the video view rate, ‘L’ is the video conversion lift, and α_{VB} is the abandonment factor for a viewer branch.

4. The method of claim 1, wherein the conversion corresponds to a customer performing one of an add-to-cart (ATC), checkout, or signing up for a trial or other product-related interaction.

5. The method of claim 1, wherein the A/B test is a video/no-video test that compares an effectiveness of video to no-video.

6. The method of claim 1, wherein the A/B test is a video/video test that compares an effectiveness of a first video to a second video.

7. The method of claim 1, wherein the gain is for a category of products.

8. A data processing system, comprising:
an experiment management engine configure to track conversion results; and
a recommendation/optimization engine coupled to the experiment management engine, wherein the recommendation/optimization engine is configured to measure a video profit of a product by:
performing an A/B test for the product while monitoring for customer conversion, wherein at least one of ‘A’ and ‘B’ correspond to video;
determining a unique number of visitors to a product webpage that viewed a call-to-action for a video of the product based on the test;
determining a gain that accounts for customer bias based on the test;
determining a non-viewer conversion rate based on the test;
determining a video view rate based on the test;
determining a video conversion lift based on the test;
determining an abandonment factor based on the test; and
determining an incremental video profit for the product based on the unique number of visitors, the gain, the non-viewer conversion rate, the video view rate, the video conversion lift, and the abandonment factor.

9. The data processing system of claim 8, wherein the recommendation/optimization engine is further configured to measure a video profit of a product by:
determining a profit margin for the product, wherein the determining, using the data processing system, an incremental video profit further comprises determining the incremental video profit based on the profit margin.

10. The data processing system of claim 9, wherein the incremental video profit P_{I} for the product is given by:
P_{I}=MIγC_{N}rLα_{VB}
where ‘M’ is the profit margin for the product, impressions ‘I’ is the unique number of visitors that viewed a call-to-action for a video of the product, γ is the gain, C_{N} is the non-viewer conversion rate, ‘r’ is the video view rate, ‘L’ is the video conversion lift, and α_{VB} is the abandonment factor for a viewer branch.

11. The data processing system of claim 8, wherein the conversion corresponds to a customer performing one of an add-to-cart (ATC), checkout, or signing up for a trial or other product-related interaction.

12. The data processing system of claim 8, wherein the A/B test is a video/no-video test that compares an effectiveness of video to no-video.

13. The data processing system of claim 8, wherein the A/B test is a video/video test that compares an effectiveness of a first video to a second video.

14. The data processing system of claim 8, wherein the gain is for a category of products.

15. A method of measuring a video profit for a product, comprising:
performing, using a data processing system, an A/B test for a product while monitoring for customer conversion, wherein at least one of ‘A’ and ‘B’ correspond to video;
determining, using the data processing system, a unique number of visitors to a product webpage that viewed a call-to-action for a video of the product based on the test;
determining, using the data processing system, a non-viewer conversion rate based on the test;
determining, using the data processing system, a view rate based on the test;
determining, using the data processing system, a video conversion lift based on the test;
determining, using the data processing system, an abandonment factor based on the test; and
determining, using the data processing system, a forecasted video profit for the product based on the unique number of visitors, the non-viewer conversion rate, the video view rate, the video conversion lift, and the abandonment factor.

16. The method of claim 15, further comprising:
determining a profit margin for the product, wherein the determining, using the data processing system, a forecasted video profit further comprises determining the forecasted video profit based on the profit margin.

17. The method of claim 16, wherein the forecasted video profit P_{F} for the product is given by:
P_{F}=MIC_{N}rLα
where ‘M’ is the profit margin for the product, impressions ‘I’ is the unique number of visitors that viewed a call-to-action for a video of the product, C_{N} is the non-viewer conversion rate, ‘r’ is the video view rate, ‘L’ is the video conversion lift, and α is the abandonment factor.

18. The method of claim 15, wherein the conversion corresponds to a customer performing one of an add-to-cart (ATC), checkout, or signing up for a trial or other product-related interaction.

19. The method of claim 15, wherein the A/B test is a video/no-video test that compares an effectiveness of video to no-video.

20. The method of claim 15, wherein the A/B test is a video/video test that compares an effectiveness of a first video to a second video.
